(19) United States
(12) Patent Application Publication
(10) Pub. No.: US 2024/0424686 A1
(43) Pub. Date: Dec. 26, 2024

(54) COMPENSATING FOR POST-SENSOR LOAD IN INTERACTION CONTROL

(71) Applicant: Intrinsic Innovation LLC, Mountain View, CA (US)

(72) Inventors: Markus Giftthaler, Freising (DE); Moritz Knaust, München (DE)

(21) Appl. No.: 18/530,968

(22) Filed: Dec. 6, 2023

Related U.S. Application Data
(60) Provisional application No. 63/509,923, filed on Jun. 23, 2023.

(51) Int. Cl. B25J 13/08

(52) U.S. Cl. CPC B25J 13/085; B25J 13/088

(57) ABSTRACT

Methods, systems, and apparatuses, including computer programs encoded on a computer storage medium, for adjusting the force value received in an interaction control system using an inertial measurement unit to account for post-sensor inertia. In one aspect, the method can include an interaction control system receiving an updated force value representing a force on the last movable component of a robot and an updated acceleration value generated by an inertial measurement unit mounted on the last component of the robot, and adjusting the force value received from the force-torque sensor based on the acceleration value received from the inertial measurement unit to generate an updated command that accounts for the post-sensor inertia.

### CLAIM OF PRIORITY

This application claims priority under 35 USC § 119(e) to U.S. Patent Application Ser. No. 63/509,923, filed on Jun. 23, 2023, the entire contents of which are hereby incorporated by reference.

### BACKGROUND

This specification relates to robotics, and more particularly to real-time robot control. Robot control refers to generating commands to effectuate the physical movements of robots in order to perform tasks, such as industrial interactions with a workpiece, an object being processed into another shape, or a human.

In this specification, a workcell is the physical environment in which a robot will operate. Workcells have particular physical properties, e.g., physical dimensions that impose constraints on how robots can move within the workcell. These changes can impact the robot's motion while being controlled by a real-time control system to accomplish a task.

These tasks can be highly specialized. For example, an industrial robot that builds cars can be programmed to first pick up a car part and then weld the car part onto the frame of the car. As another example, a robot can pick up components for placement on a printed circuit board. Programming a robot to perform these actions can require planning and scheduling dozens or hundreds of individual movements by robot motors and actuators. In particular, the actions of the robot are accomplished by one or more end effectors mounted at the end, or last link of one or more moveable components, of the robot that are designed to interact with the environment.

A real-time control system uses a real-time controller to dictate what action or movement a robot should take during every period of a control cycle. In this specification, a real-time control system is a software system that is required to perform actions within strict timing requirements in order to achieve normal operation. The timing requirements often specify that certain processes must be executed or certain outputs must be generated within a particular time window in order for the system to avoid entering a fault state. In the fault state, the system can halt execution or take some other action that interrupts normal operation of a robot.

A real-time control system can use a variety of methods to control the robot. As one example, admittance control is often used in applications where robots need to interact with the environment, specifically with a workpiece or with humans in a workcell. Admittance control can be used in manufacturing, surgery, and rehabilitation. As another example, admittance control can also be used in virtual reality applications, where robots can be used to create haptic feedback.

However, one of the primary limitations of admittance control, as well as other real-time control techniques, is that it is not possible to account for all forces that might be acting on the end effector. This is particularly a problem with “high post-sensor inertia” applications in which the end effector must manipulate a high payload object. In this case, the high post-sensor inertia can introduce interaction dynamics that significantly impact overall sensor readings and confound the motion of the robot, which can lead to instability. Complex modeling techniques that attempt to compensate for this confounding motion are unable to account for all structural dynamics of the robot in the workcell and also are not suitable for real-time control systems that have strict requirements on timing and determinism.

### SUMMARY

This specification describes a real-time robotics control system that can use an inertial measurement unit (IMU) to appropriately adjust the force value received from a force-torque (FT) sensor to correct for both accelerations from the robot motion itself and accelerations from unmodeled structural dynamics from the workcell in an interaction control system. These techniques can be particularly useful in high-payload settings in which the inertia of the workpiece causes significant unwanted post-sensor forces on the robot.

In this specification, an interaction control system refers to any appropriately configured robotics control system that employs any of a collection of robotic control techniques that rely on using force measurements to compute a position or a joint command. Interaction control systems typically aim to control a robot to interact with an environment, often with a workpiece or with humans in a workcell. For example, admittance control, explicit force control, position control, compliance control, and impedance control are all examples of interaction control systems. Furthermore, the techniques described in this specification are applicable to any appropriate interaction task with a high payload. Robot motions, no matter what control technique is being used, can be improved by removing spurious forces from accelerations from the robot itself and unmodeled structural dynamics from the control loop using the IMU to adjust the force value.

Particular embodiments of the subject matter described in this specification can be implemented so as to realize one or more of the following advantages. Using an IMU mounted alongside an FT sensor on the end effector allows a robot to become even more compliant and interactive with a potentially changing workcell than using an FT sensor alone. Specifically, the incorporation of the IMU allows a robot to even more precisely follow the external forces of the workcell by calculating the desired joint position, velocity, and acceleration using updated equations of motion of a virtual object in response to these external forces. An FT sensor alone cannot sense or correct for unwanted forces from the robot motion itself and unmodeled structural dynamics. The inclusion of an IMU allows the robot to sense and react to these potentially confounding movements.

The IMU provides the capability for obtaining direct and near-instantaneous high-fidelity estimates of both unwanted forces—from the robot motion itself and unmodeled structural dynamics—in task (Cartesian) space. This is more straightforward and robust against inaccuracies in kinematic modeling than other techniques that use joint-encoder readings to reconstruct acceleration from position measurements in the robot's frame of motion and map them to task-space using a change of coordinates to compute a dynamic force estimate. Furthermore, acceleration reconstruction does not yield high-fidelity estimates, due to strong low-pass filtering, which causes signal delays, and noise introduced by the required double differentiation from noisy position measurements.

Additionally, the proposed method can importantly model unwanted structural dynamics, like workcell oscillations or structural resonance, that other reconstruction techniques cannot account for. These unmodeled dynamics constitute a major source of instability in normal industrial settings and the IMU's ability to directly sense these unmodeled dynamics and compensate for them in the control scheme in a straightforward way allows for less conservative controller tuning, therefore unlocking better cycle times. Under the design of the real-time robotics control system described in this specification, the system can incorporate real-time force-torque and inertial sensor information, even in a hard real-time system. Using the IMU, the robot can generate an updated interaction control system command based on the adjusted force reading. This allows the real-time system to react to both the sensed force from the FT sensor and external force stimuli, including unwanted forces from the robot motion itself and unmodeled structural dynamics, in a reactive feedback control system, resulting in a higher fidelity of motion in real-time.

Additionally, the described interaction control correction scheme can provide sensor measurements to a real-time robotic control system for use in computing a custom action, and receiving hardware control inputs computed for the custom action from the real-time robotic control system, all while maintaining the tight timing constraints of the real-time robot control system, e.g., at the order of one millisecond.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example real-time robotics system that features an example inertial measurement unit correction scheme.

FIG. 2 is a system diagram of an example robot interacting with a high post-sensor inertia.

FIG. 3 is a flow chart of an example process for adjusting the force value received from the force-torque (FT) sensor based on the acceleration value received from the inertial measurement unit (IMU) to account for a high post-sensor inertia.

Like reference numbers and designations in the various drawings indicate like elements.

### DETAILED DESCRIPTION

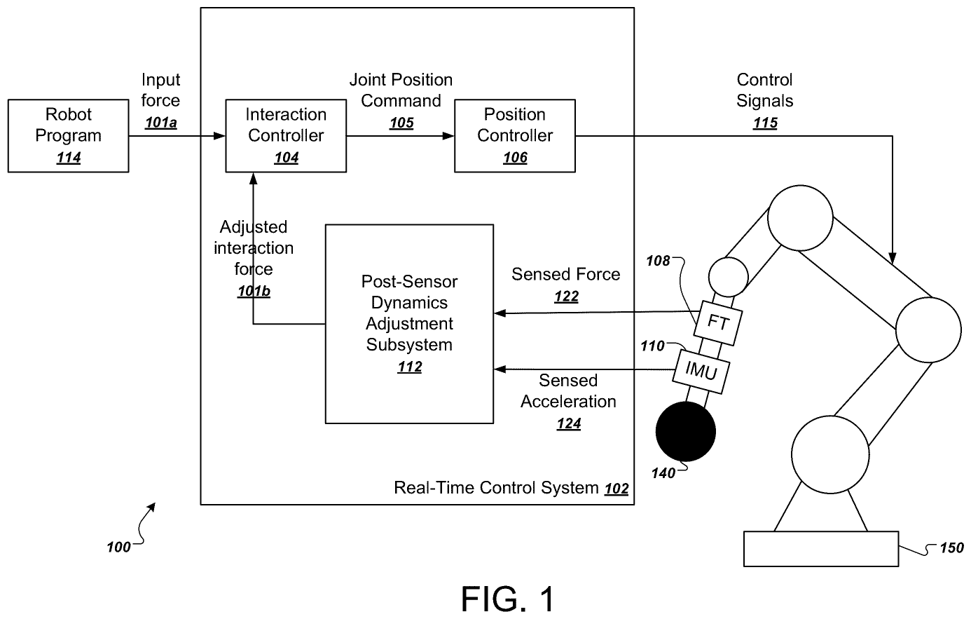

FIG. 1 is a block diagram of an example real-time robotics system 100 that features an inertial measurement unit (IMU) acceleration correction scheme. The system 100 includes a real-time control system 102 that has an interaction controller 104, a position controller 106, and a post-sensor dynamics adjustment subsystem 112. Each of these components can be implemented as software modules installed on one or more computers in one or more locations. In some implementations, these modules of the real-time control system 102 are configured to operate according to the determinism and timing constraints of real-time robotics control. In other words, these components are configured to deterministically process an input to generate an output within each tick of the real-time control cycle.

The real-time control system 102 drives the actions of a robot 150, which has a mounted force-torque (FT) sensor 108 and a mounted IMU 110. The FT sensor 108 and the IMU 110 are illustrated as being mounted on a last moveable component 130 of the robot before the end effector 132. In this example, the robot 150 is illustrated using the end effector 132 to lift a payload 140. These components can function to determine the properties and forces of robotic motion in a workcell environment at every tick of a real-time control cycle including adjusting the force value at each tick.

More specifically, the interaction controller 104 controls a robot 150 having one or more moveable components, such as joints in a robotic arm, and an end effector 120, such as a drill head or a claw hand, to perform the actions of a robot program 114. In general, the interaction controller 104 generates goal joint positions using a joint position command 105, which are then provided to a position controller 106. The position controller 106 generates the appropriate control signals 115 for driving motors, actuators, drives, or some combination of these, of the robot 150 to effectuate the goal joint positions.

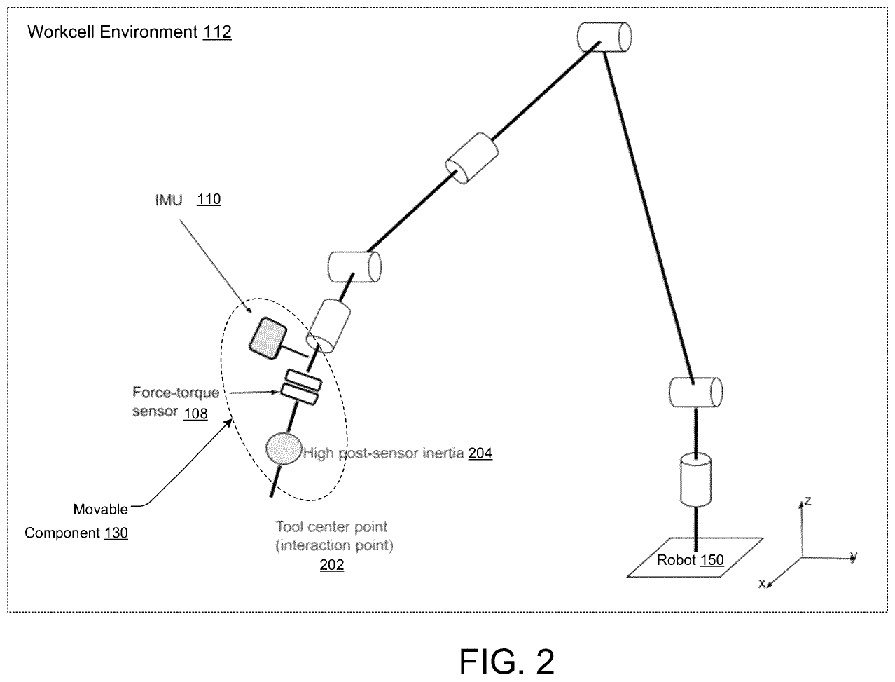

The robot program 114 can be a set of encoded instructions that specify how the robot 150 should perform a particular task on the payload 140. When executed by an appropriately programmed real-time or non-realtime computer system, the robot program 114 can provide an input force 101a to the interaction controller 104. The FT sensor 108 and the IMU 110 can be placed on the same movable component, e.g., the component 130, and, in some cases, this movable component can be the last one, i.e., the one nearest to the end effector 120. The components of an example robot of this system 100 will be covered in more detail in FIG. 2.

The robot program 114 can pertain to high-payload or high post-sensor inertia tasks, where the payload 140 is located after the FT sensor 108 along connected components from a base of the robot, e.g., the last moveable component 130. In certain cases, the system 100 is particularly advantageous for correcting for post-sensor inertia generated by payloads having a mass greater than 100 kg. An example task can include picking up a heavy steel plate for manufacturing a skyscraper support beam. In this case, the robot program 114 can instruct the robot to pick up the heavy steel plate, place it in a furnace, remove it after a predetermined time, and manipulate it into the desired beam shape while malleable. Tasks can be specified in Cartesian position space. This is in contrast to joint space, which refers to the translation and angular displacement of the robot's movable components in the robot's frame of reference.

The post-sensor dynamics adjustment subsystem 112 can correct force readings from the FT sensor 108 using accelerations sensed by the IMU 110. Thus, the post-sensor dynamics adjustment subsystem 112 receives a sensed force 122 from the FT sensor 108 and a sensed acceleration 124 from the IMU 110. The post-sensor dynamics adjustment subsystem 112 can then employ one or more dynamics models to generate an adjusted interaction force 110b, which is provided back to the interaction controller 104.

In interaction control, the robot follows external contact forces to accomplish the instructions of the robot program 114. Specifically, within an example context of admittance control, the interaction controller 104 can process the forces 101a to calculate desired robot joint positions and motion in joint space using kinematic equations of motion for virtual object joint position, velocity, and acceleration. The interaction controller 104 instructs the position controller 104 using joint position commands 105 to actuate the joint position, velocity, and acceleration of the robot using control signals 115 that achieve the desired motion.

In particular, admittance control follows the simplified equation of motion:

$$Ma + Dv + Kx = {F}_{sensed} - {F}_{desired} \qquad ( 1 )$$

Where x denotes Cartesian position, v is velocity, a is acceleration, K is the stiffness of the controller, D is the damping coefficient, and M is a desired virtual inertia. While the above equation is overly simplistic, it illustrates the concept of indirect interaction force control. Solving for the acceleration a, yields a nominal Cartesian acceleration which will realize the desired nominal commanded contact force F_{desired} using the force sensed by the FT sensor 108 F_{sensed}.

However, in practice, the actuated robot motion in the environment 112 results in multiple forces, including the desired nominally commanded motion of the robot F_{desired}; and also unwanted forces, such as accelerations from the motion of the robot itself and unmodeled structural dynamics that occur from the robot 150 moving in confounding ways while trying to achieve the commanded motion. In this system 100, these confounding motions are handled by the post-sensor dynamics adjustment subsystem 112, which will be covered in further detail below.

In particular, while the commanded motion is carried out, the robot itself might accelerate in a way opposite to the desired motion. For example, when accelerating towards or away from a payload 140, e.g. a high post-sensor inertia payload, the robot's motion can lead to a force acting opposite to the direction of the desired acceleration that causes the force actuated to be less than the nominal desired force. In particular, when trying to retract the end effector 120 up from contact with a work surface, the payload 140 will result in a force pointing down due to gravity which pulls the end effector 120 in the opposite direction of the desired motion. Despite being able to solve for the nominally commanded acceleration, the actually occurring acceleration at the end effector 120 is very hard to predict. Delays due to manipulator dynamics, friction effects, nonlinear control terms, etc. can render an accurate prediction of end effector 140 acceleration (and thus post-sensor inertia reaction force) difficult.

Additionally, robot systems are generally not interconnections of perfectly rigid bodies. Specifically, not all robots are mounted in a workcell in a perfectly rigid fashion, i.e., the manipulator and workcell themselves form a resonating coupled system. This elastic coupled robot-workcell system has unmodeled structural dynamics that result in oscillations during and after a nominal motion has been finished. These effects can usually not be modeled, are almost impossible to predict, and are very workcell-specific. They can lead to significant disturbances in the force-signal sensed at the end-effector 120.

The simplified admittance control equation of motion can be augmented by an IMU 110 that can sense post-sensor inertia effects in real-time and provide a correction value that updates the force of the end effector 120 using a post-sensor dynamics adjustment subsystem 112. In some examples, the IMU 110 can be an off-the-shelf accelerometer, a cell phone, or another device that can provide an updated acceleration value of the robot's 150 motion with multiple degrees of freedom in task (Cartesian) space. In a particular example, the IMU 110 can provide an updated acceleration value sensed with six degrees of freedom. An updated control law that takes these confounding effects into account reads:

$$Ma + Dv + Kx = {F}_{interaction} + {F}_{ps - dynamics} + {F}_{ps - static} - {F}_{desired} \qquad ( 2 )$$

with F_{ps-static} representing the static post-sensor (“ps”) due to gravity, F_{ps-dynamics} representing dynamic reactions due to accelerated post-sensor inertia, and only F_{interaction} being the “quantity of interest” for interaction control. F_{ps-static} can be trivially compensated, therefore we will neglect it in the following which focuses instead on F_{ps-dynamics}. The post-sensor dynamics adjustment system 112 processes the sensed force 122 from the FT sensor 108 and the sensed acceleration 124 from the IMU 110 using this updated control law to calculate an adjusted interaction force 101b that is sent to the interaction controller 104.

Acceleration is provided instead of force because interactions with the workcell environment 112 are not necessarily determined, i.e. they can be unknown. For example, at any time the robot 150 might contact a human or workpiece which can cause unwanted confounding motion from the robot and the coupled robot-workcell system. Since the forces from the motion of the robot itself and unmodeled structural dynamics are relatively unknown, the acceleration is used since it can be combined with the post-sensor inertia into a force.

This updated acceleration reading can be processed by a post-sensor dynamics adjustment subsystem 112 that serves to multiply the acceleration reading of the mass of the post-sensor inertia into an adjusted interaction force 101b that can be used to correct the force 101a through subtraction before it enters the control loop. In particular,

$$Ma + Dv + Kx = {F}_{sensed} - {m}_{ps} {a}_{sensed} - {F}_{desired} \qquad ( 3 )$$

where mₚₛ is the identified post-sensor inertia and a_{sensed} is the updated sensed acceleration from the IMU 110. The quantity mₚₛa_{sensed} serves as an estimate for F_{ps-dynamics}, i.e. the adjusted force value that accounts for confounding effects from the post-sensor inertia.

In some cases, the damping coefficient (D) can be tuned, specifically to overdampen the system, to correct for some of the confounding motions that come from the robot's 150 own motion. Overdamping refers to increasing the damping configuration of the system, i.e., causing the robot 150 to return to equilibrium with less motion. As an example of a damped system, an automatic door close uses a spring to automatically return the door to its closed position more slowly than it would without the spring. However, the tuning of a damping configuration for tasks is time-consuming and applying an aggressive damping configuration slows down cycle time, the time it takes the robot to complete a task, which makes the process more costly. In addition, this overdamping cannot correct for the unmodeled structural dynamics, so it only corrects for the part of the confounding motion that comes from the robot 150 moving itself.

This system 100 can use the adjusted interaction force 101b value to operate the robot 150 with less conservative damping values whenever the IMU 110 is activated. This enables more stable contact with the workcell, which speeds up the cycle time of the process, and reduces the cost of manufacturing.

FIG. 2 is a system diagram of an example real-time robotics system 100. The system 100 includes a robot 150 interacting with a high post-sensor inertia 204—which can include both the end effector 120 and payload 140—located on a specific moveable component 130. In this example, the moveable component 130 is the last moveable component of the robot. The IMU 110, FT sensor 108, and high post-sensor inertia 204 are all located on the last moveable component in this example, which also includes the tool center point (interaction point) 202. In particular, the IMU 110 is located before the FT sensor 108 on the last moveable component, but it can be placed anywhere on the last moveable component in other examples. The tool center point is a particular example of an end effector that enables the robot 150 to interact with a workpiece or a human within the workcell environment 112.

When the robot 150 is operated without the IMU 110 activated, the robot 150 follows external motions and the system receives the FT sensor 108 force measurement on the end effector, the tool center point (interaction point) 202, and calculates the desired joint position, velocity, and acceleration using the equation of motion of a virtual object in response to external forces. The interaction control system generates a command that controls the robot to actuate the desired motion in accordance with these calculations to achieve the nominally commanded motion of the robot F_{desired}, but the high post-sensor inertia 204 confounds the motion. In particular, the high post-sensor inertia 204 results in unwanted accelerations from the motion of the robot itself and unmodeled structural dynamics, as discussed in FIG. 1, that can destabilize the system.

As an example, the part of this unwanted motion that comes from the robot moving itself while trying to achieve the desired motion can be corrected by overdamping the system, as discussed in FIG. 1. For example, this can be achieved by computing the damping constant D in Eq. 1 using existing stiffness K and inertia M, and then scaling D by a “safety” overdamping factor to generate a D_{safe}. As an example, D_{safe} can be calculated by multiplying D by a factor of 10, 100, or any other appropriate value.

In contrast, when the robot 150 is operated with the IMU 110 activated, the robot 150 follows external motions and the system receives the FT sensor 108 force measurement on the end effector, the tool center point (interaction point) 202, and calculates the desired joint position, velocity, and acceleration using the equation of motion of a virtual object in response to the external forces. The interaction control system controls the robot to actuate the desired motion in accordance with these calculations to achieve the nominally commanded motion of the robot F_{desired} by taking into account an updated command, which includes an adjusted force value that accounts for the high post-sensor inertia 204. The IMU 110 provides an updated acceleration value that is used to correct for the unwanted accelerations from the motion of the robot itself and unmodeled structural dynamics.

In this case, the desired motion can be achieved using a less conservative damping configuration. In particular, using the IMU 110 to provide an updated force value allows for more stable contact with the workcell environment, which speeds up cycle time and decreases the cost of manufacturing.

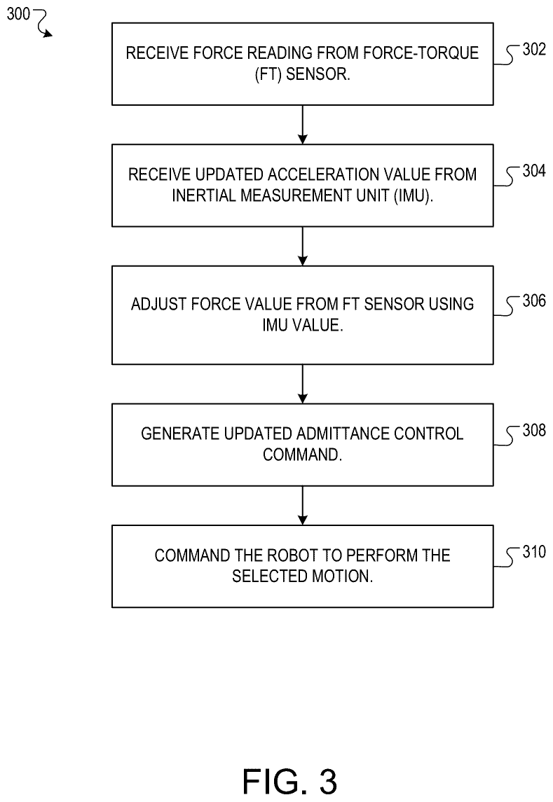

FIG. 3 is a flow diagram of an example process 300 for adjusting the force value received from the force-torque (FT) sensor based on the acceleration value received from the inertial measurement unit (IMU) to account for high post-sensor inertia. For convenience, the process 300 will be described as being performed by a system of one or more computers located in one or more locations that can collaborate to control a robot using a real-time interaction control system. For example, a real-time robotics system, e.g., the real-time control system 102 of FIG. 1, appropriately programmed in accordance with this specification, can perform the process 300.

This real-time interaction control system generates a command at every tick of a real-time control cycle, and further comprises adjusting the force value at every tick of the real-time control cycle. More specifically, the system receives an updated force value from the FT sensor at every tick of the real-time control cycle (step 302). The system also receives an updated acceleration value from the IMU (step 304). Both the FT and IMU sensors can be located on the same movable component of the robot. For example, in some cases, the FT sensor and IMU can be mounted on the last moveable component, i.e., the one nearest to the end effector and the payload. In particular examples with high post-sensor inertia, the payload can be a mass over 100 kg.

The system adjusts the force value from the FT sensor using the IMU acceleration value (step 306). Specifically, the system can subtract off the quantity of the mass of the post-sensor inertia multiplied by the updated acceleration value to correct forces from any unwanted confounding motion, including acceleration from motion of the robot itself and unmodeled structural dynamics. This correction removes the need to employ and tune a conservative damping configuration to counteract the confounding motion when the IMU is not activated.

The system then generates an updated command based on the adjusted force value using interaction control (step 308). This updated command causes the robot to perform the selected motion with higher fidelity given any payload, and, in particular, given a high-post sensor payload. This updated command is able to yield higher fidelity motions in real-time. The IMU correction compensates for both accelerations from the motion of the robot itself and unwanted structural oscillations at the same time in a workcell in a reliable and scalable way, thereby achieving maximum interaction controller performance.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g, a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain cases, multitasking and parallel processing may be advantageous.

What is claimed is:

1. A computer-implemented method comprising:
receiving, in an interaction control system comprising a robot having a plurality of moveable components and a force-torque sensor mounted on a first component of the one or more movable components to measure forces on an end effector of the robot, an updated force value representing a force on the end effector;
receiving, by the interaction control system, an updated acceleration value generated by an inertial measurement unit mounted on the first component of the robot;
adjusting the force value received from the force-torque sensor based on the acceleration value received from the inertial measurement unit to account for post-sensor inertia of the end effector; and
generating, by the interaction control system, an updated command based on the adjusted force value that accounts for the post-sensor inertia.

2. The method of claim 1, wherein the force-torque sensor and the inertial measurement unit are both mounted on a last component of the robot nearest to the end effector.

3. The method of claim 2, wherein the post-sensor inertia is generated by a payload having a mass greater than 100 kg.

4. The method of claim 3, further comprising:
operating the robot with a first damping configuration whenever the inertial measurement unit is not activated; and
operating the robot with a second damping configuration that generates less conservative damping values whenever the inertial measurement unit is activated.

5. The method of claim 4, wherein adjusting the force value comprises adjusting the force value to correct accelerations from motion of the robot itself.

6. The method of claim 5, wherein adjusting the force value comprises adjusting the force value to correct for unmodeled structural dynamics.

7. The method of claim 6, wherein the interaction control system is a real-time interaction control system that generates a command at every tick of a real-time control cycle, and further comprising adjusting the force value at every tick of the real-time control cycle.

8. The method of claim 7, wherein the interaction control system is an admittance control system or an impedance control system.

9. A system comprising one or more computers and one or more storage devices storing instructions that are operable, when executed by the one or more computers to cause the one or more computers to perform operations comprising:
receiving, in an interaction control system comprising a robot having a plurality of moveable components and a force-torque sensor mounted on a first component of the one or more movable components to measure forces on an end effector of the robot, an updated force value representing a force on the end effector;
receiving, by the interaction control system, an updated acceleration value generated by an inertial measurement unit mounted on the first component of the robot;
adjusting the force value received from the force-torque sensor based on the acceleration value received from the inertial measurement unit to account for post-sensor inertia of the end effector; and
generating, by the interaction control system, an updated command based on the adjusted force value that accounts for the post-sensor inertia.

10. The system of claim 9, wherein the force-torque sensor and the inertial measurement unit are both mounted on a last component of the robot nearest to the end effector.

11. The system of claim 10, wherein the post-sensor inertia is generated by a payload having a mass greater than 100 kg.

12. The system of claim 11, wherein the operations further comprise:
operating the robot with a first damping configuration whenever the inertial measurement unit is not activated; and
operating the robot with a second damping configuration that generates less conservative damping values whenever the inertial measurement unit is activated.

13. The system of claim 12, wherein adjusting the force value comprises adjusting the force value to correct accelerations from motion of the robot itself.

14. The system of claim 13, wherein adjusting the force value comprises adjusting the force value to correct for unmodeled structural dynamics.

15. The system of any one of claim 14, wherein the interaction control system is a real-time interaction control system that is configured to generate a command at every tick of a real-time control cycle, and further comprising adjusting the force value at every tick of the real-time control cycle.

16. The system of any one of claim 15, wherein the interaction control system is an admittance control system or an impedance control system.

17. A computer storage medium encoded with a computer program, the program comprising instructions that are operable, when executed by data processing apparatus to cause the data processing apparatus to perform operations comprising:
receiving, in an interaction control system comprising a robot having a plurality of moveable components and a force-torque sensor mounted on a first component of the one or more movable components to measure forces on an end effector of the robot, an updated force value representing a force on the end effector;
receiving, by the interaction control system, an updated acceleration value generated by an inertial measurement unit mounted on the first component of the robot;
adjusting the force value received from the force-torque sensor based on the acceleration value received from the inertial measurement unit to account for post-sensor inertia of the end effector; and
generating, by the interaction control system, an updated command based on the adjusted force value that accounts for the post-sensor inertia.

18. The computable-readable medium of claim 17, wherein the force-torque sensor and the inertial measurement unit are both mounted on a last component of the robot nearest to the end effector.

19. The computable-readable medium of claim 18, wherein the operations further comprise:
operating the robot with a first damping configuration whenever the inertial measurement unit is not activated; and
operating the robot with a second damping configuration that generates less conservative damping values whenever the inertial measurement unit is activated.

20. The computable-readable medium of claim 19, wherein adjusting the force value comprises:
adjusting the force value to correct accelerations from motion of the robot itself; and
adjusting the force value to correct for unmodeled structural dynamics.
